(19) United States
(12) Patent Application Publication
(10) Pub. No.: US 2019/0092056 A1
(43) Pub. Date: Mar. 28, 2019

(54) PRINTING DEVICE, PRINTING METHOD, AND RECORDING MEDIUM

(71) Applicant: CASIO COMPUTER CO., LTD., Tokyo (JP)

(72) Inventor: Takayuki HIROTANI, Tokyo (JP)

(73) Assignee: CASIO COMPUTER CO., LTD., Tokyo (JP)

(21) Appl. No.: 16/137,288

(22) Filed: Sep. 20, 2018

(30) Foreign Application Priority Data
Sep. 22, 2017 (JP) 2017-182243

(51) Int. Cl. B41J 25/00; B41J 29/38

(52) U.S. Cl. CPC B41J 25/006; B41J 29/38

(57) ABSTRACT

A printing device includes a housing having at a bottom surface thereof a print head in which printing elements are arrayed linearly in a main scanning direction, a detector configured to detect a movement distance of the housing in a sub-scanning direction, an inputter configured to input an instruction to start printing, an indicator disposed on an edge portion of the housing and configured to indicate a planned print position on a printing medium, and a processor. The processor is configured to determine whether the housing has been moved in the sub-scanning direction by a standard distance between the indicator and the print head in the sub-scanning direction after inputting by the inputter of the instruction to start printing, and cause the print head to start printing at a start printing position that is a position to which the housing has been moved in the sub-scanning direction by the standard distance.

### CROSS-REFERENCE TO RELATED APPLICATION

This application is based upon and claims the benefit of priority under 35 USC 119 of Japanese Patent Application No. 2017-182243, filed on Sep. 22, 2017, the entire disclosure of which, including the description, claims, drawings, and abstract, is incorporated herein by reference in its entirety.

### FIELD

The present disclosure relates to a printing device, a printing method, and a recording medium.

### BACKGROUND

A manually scanning-type printing device is known that, by a user grasping a housing by the hand and manually scanning, prints a print subject such as characters, symbols, logos, marks, and the like on a printing medium. A print head is arranged at a bottom surface of the housing, and thus the manually scanning-type printing device has a problem in that a position of the printing on the printing medium is difficult to recognize.

U.S. Patent Application Publication No. 2007/0223982 discloses a manually scanning-type printing device that, in order to make the position of printing on the printing medium easier to recognize, includes a standard indicator arranged in the vicinity of the bottom surface of the housing, and a display that displays a relative positional relationship between the standard indicator and an image to be printed. Although this printing device enables a user to recognize the positional relationship between the standard indicator and the printed image, accurate recognition of where the printing starts is difficult. Thus when using this device printing the print subject at a location desired by the user is difficult.

An objective of the present disclosure is to provide a printing device, a printing method, and a recording medium that have an advantage of enabling easy printing at a desired location.

### SUMMARY

An aspect of the present disclosure is a printing device that includes:

a housing having at a bottom surface thereof a print head in which printing elements are arrayed linearly in a main scanning direction;

a detector configured to detect a movement distance of the housing in a sub-scanning direction;

an inputter configured to input an instruction to start printing;

an indicator disposed on an edge portion of the housing and configured to indicate a planned print position on a printing medium; and

a processor configured to determine whether the housing has been moved in the sub-scanning direction by a standard distance between the indicator and the print head in the sub-scanning direction after inputting by the inputter of the instruction to start printing, and cause the print head to start printing at a start printing position that is a position to which the housing has been moved in the sub-scanning direction by the standard distance.

Another aspect of the present disclosure is a printing method of a printing device including a housing having at a bottom surface thereof a print head in which printing elements are arrayed linearly in a main scanning direction, a detector for detecting a movement distance of the housing in a sub-scanning direction, and an indicator disposed on an edge portion of the housing for indicating a planned print position on a printing medium. The method includes:

giving an instruction to start printing;

determining by the detector whether the housing has been moved in the sub-scanning direction by a standard distance between the indicator and the print head in the sub-scanning direction after the giving of the instruction to start printing; and

causing the print head to start printing at a start printing position that is a position to which the housing has been moved in the sub-scanning direction by the standard distance.

Another aspect of the present disclosure is a non-transitory computer-readable recording medium, storing a program for execution by a computer to control a printing device including a housing having at a bottom surface thereof a print head in which printing elements are arrayed linearly in a main scanning direction, a detector for detecting a movement distance of the housing in a sub-scanning direction, and an indicator disposed on an edge portion of the housing for indicating a planned print position on a printing medium, and an inputter for inputting that the indicator is positioned at an edge portion of the planned print position, the program causing the computer to:

determine by the detector whether the housing has been moved in the sub-scanning direction by a standard distance between the indicator and the print head in the sub-scanning direction after inputting by the inputter, and cause the print head to start printing at a start printing position that is a position to which the housing has been moved in the sub-scanning direction by the standard distance.

### BRIEF DESCRIPTION OF THE DRAWINGS

A more complete understanding of this application can be obtained when the following detailed description is considered in conjunction with the following drawings, in which:

FIG. 1 is a drawing illustrating a handy printer and a terminal device according to an embodiment of the present disclosure;

FIG. 2 is a top view illustrating the handy printer according to the embodiment of the present disclosure;

FIG. 3 is a bottom surface view of the handy printer according to the embodiment of the present disclosure;

FIG. 4 is a block diagram illustrating a configuration of the handy printer according to the embodiment of the present disclosure;

FIG. 5 is a block diagram illustrating a configuration of the terminal device according to the embodiment of the present disclosure;

FIG. 6 is a flow chart illustrating print subject transmission processing executed by the terminal device according to the embodiment of the present disclosure;

FIG. 7 is a flow chart illustrating print processing executed by the handy printer according to the embodiment of the present disclosure;

FIG. 8 is a flow chart illustrating a first print start processing executed by the handy printer according to the embodiment of the present disclosure;

FIG. 9 is a flow chart illustrating a second print start processing executed by the handy printer according to the embodiment of the present disclosure;

FIG. 10 is a drawing for description of the print processing executed by the handy printer according to the embodiment of the present disclosure;

FIG. 11 is a drawing for description of the print processing executed by the handy printer according to the embodiment of the present disclosure;

FIG. 12 is a drawing for description of the print processing executed by the handy printer according to the embodiment of the present disclosure;

FIG. 13 is a drawing for description of the print processing executed by the handy printer according to the embodiment of the present disclosure;

FIG. 14 is a drawing for description of the print processing executed by the handy printer according to the embodiment of the present disclosure; and

FIG. 15 is a top view illustrating a handy printer according to a modified example of the present disclosure.

### DETAILED DESCRIPTION

A printing device according to embodiments of the present disclosure is described below with reference to drawings.

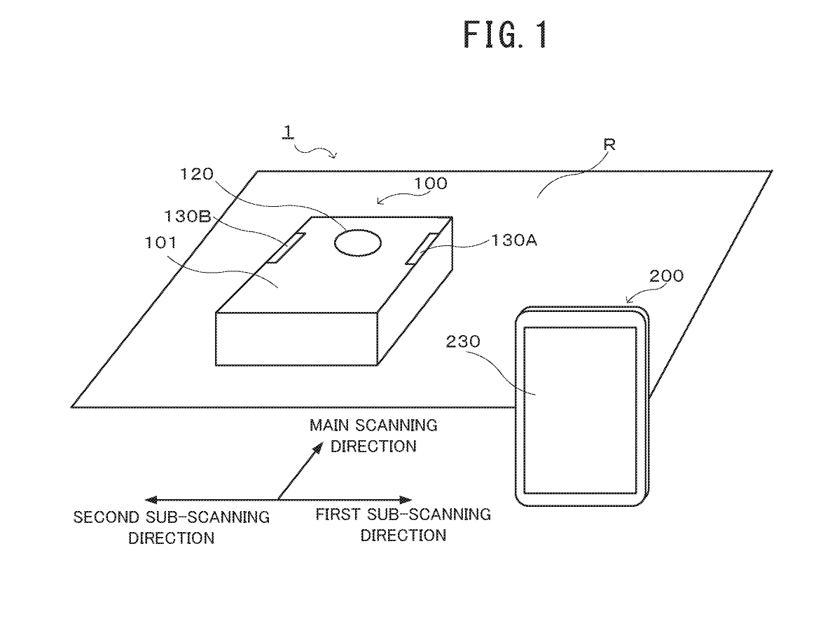

As illustrated in FIG. 1, a handy printer (printing device) 100 according to an embodiment of the present disclosure is equipped with a housing 101 that has a size so as to be easily grasped by a hand of a user; the user sweeps the handy printer 100 in a first or second sub-scanning direction; and the handy printer prints a print subject such as characters, symbols, logos, marks, and the like on a printing medium R. Data indicating the print subject printed by the handy printer 100 is transmitted from a terminal device 200. The terminal device 200, for example, includes a smartphone or a tablet personal computer (PC) equipped with a display 230. The handy printer 100 and the terminal device 200 are configured so as to be capable of communicating with each other via a wireless link. A printing system 1 includes the handy printer 100 and the terminal device 200.

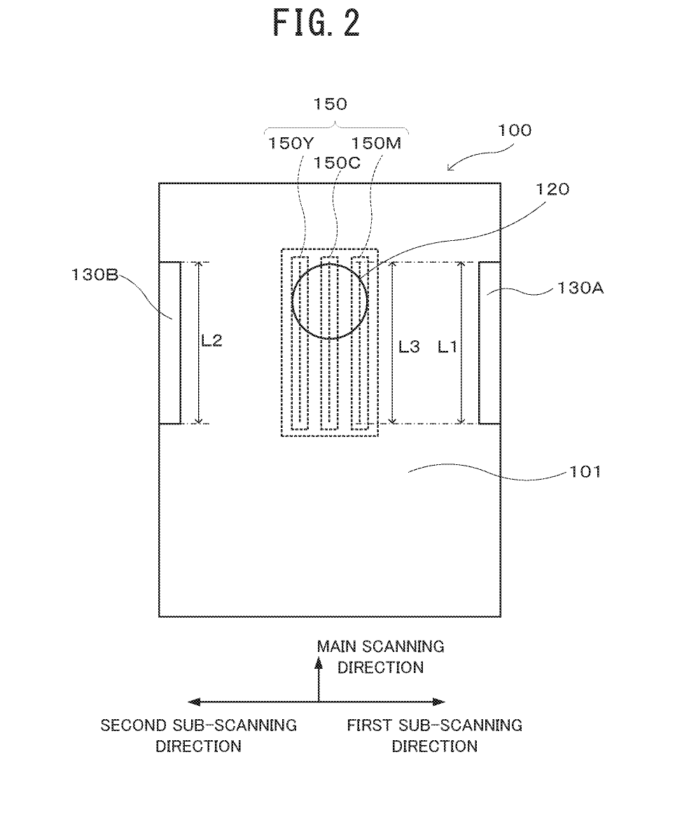

As illustrated in FIG. 2, a determination button 120 for receiving an instruction for a start of printing and a first indicator 130A and a second indicator 130B for indicating a position of the start of printing are arranged on a top surface of the handy printer 100.

The first indicator 130A is disposed at a right edge portion of the housing 101 as viewed from above, is a part aligned with an edge portion of a planned print position P on a printing medium R in the case of printing by movement in the first sub-scanning direction, and indicates a printing width. In a similar manner, the second indicator 130B is disposed at a left edge portion of the housing 101 as viewed from above, is a part aligned with an edge portion of the planned print position P on the printing medium R in the case of printing by movement in the second sub-scanning direction, and indicates the printing width. Each of the first indicator 130A and the second indicator 130B has a light guide plate and a light emitting diode (LED) for emitting red light, an LED for emitting green light, and an LED for emitting blue light, and emits light of a freely-selected color. Each of the first indicator 130A and the second indicator 130B has a shape extending in a direction parallel to a main scanning direction of a below-described print head 150; and a length L1 in the main scanning direction of the first indicator 130A and a length L2 in the main scanning direction of the second indicator 130B are the same as a length L3 in the main scanning direction of the print head 150. When the handy printer 100 is viewed from above, the first indicator 130A is disposed at a position of overlap with the print head 150 upon a below-described standard distance movement in the first sub-scanning direction. The second indicator 130B is disposed at a position of overlap with the print head 150 upon the standard distance movement in the second sub-scanning direction.

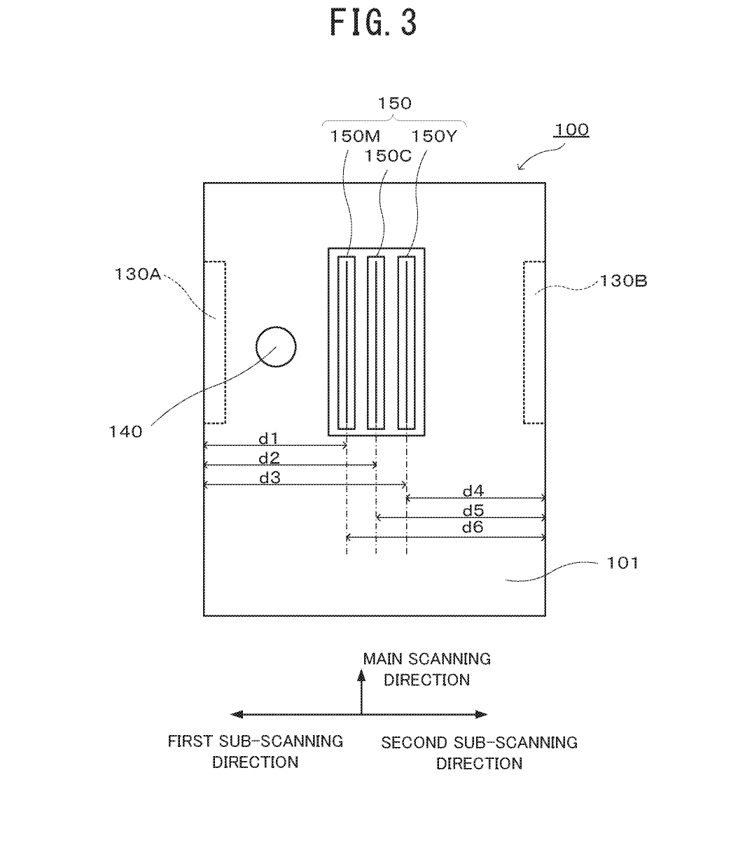

As illustrated in FIG. 3, a movement distance detector 140 and the print head 150 are arranged at the bottom surface of the handy printer 100.

The movement distance detector 140 includes components such as an optical detector and a light source such as an LED, and detects a movement distance of the handy printer 100 moved in the first or second sub-scanning direction.

The print head 150 includes a magenta-color print head 150M that discharges magenta-colored ink, a cyan-color print head 150C that discharges cyan-colored ink, a yellow-color print head 150Y that discharges yellow-colored ink, and non-illustrated ink tanks for each of the colors. In the print heads 150M, 150C, and 150Y, nozzles, as the printing elements of each print head, are arrayed linearly in the main scanning direction.

Further, the main scanning direction is perpendicular to the first and second sub-scanning directions. The print head 150 discharges ink selectively from the nozzles in accordance with electrical energization corresponding to an image of a print subject. The magenta-color print head 150M is disposed at a position that is a standard distance d1 from an edge portion of the first indicator 130A, and is disposed at a position that is a standard distance d6 from an edge portion of the second indicator 130B. The cyan-color print head 150C is disposed at a position that is a standard distance d2 from the edge portion of the first indicator 130A, and is disposed at a position that is a standard distance d5 from the edge portion of the second indicator 130B. The yellow-color print head 150Y is disposed at a position that is a standard distance d3 from the edge portion of the first indicator 130A, and is disposed at a position that is a standard distance d4 from the edge portion of the second indicator 130B.

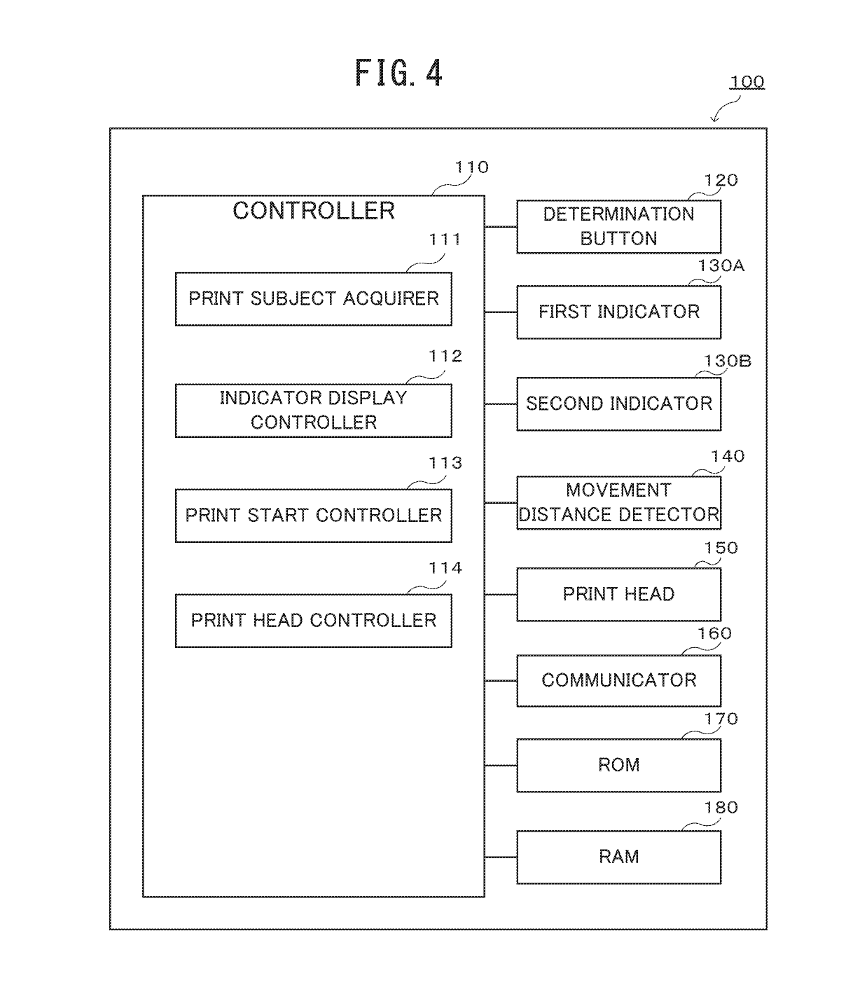

As illustrated in FIG. 4, electrical configuration of the handy printer 100 includes the determination button 120, the first indicator 130A, the second indicator 130B, the movement distance detector 140, and the print head 150, as mentioned above, as well as a controller 110, a communicator 160, a read only memory (ROM) 170, and a random access memory (RAM) 180.

The controller 110 includes components such as a central processing unit (CPU). By executing a program stored in the ROM 170, the controller 110 functions as a print subject acquirer 111, an indicator display controller 112, a print start controller 113, and a print head controller 114.

Via the communicator 160, the print subject acquirer 111 acquires data indicating the print subject and a movement direction that are transmitted from the terminal device 200, and stores the acquired data in the RAM 180.

The indicator display controller 112 turns ON lighting of the first indicator 130A or the second indicator 130B in accordance with the movement direction. Upon the print subject acquirer 111 acquiring data indicating printing by movement in the first sub-scanning direction, the indicator display controller 112 turns ON lighting of the first indicator 130A. In the case in which preheating is in progress for the print head 150 due to control by the indicator display controller 112, the first indicator 130A is lit red, which is the color that indicates that preheating is in progress. When preheating is completed and a print wait state is entered, the first indicator 130A is lit green, which is the color that indicates the print wait state. When the determination button 120 is pressed, the first indicator 130A is lit white, which is the color that indicates the start of movement. When by the handy printer 100 has been moved by the standard distance d1 after pressing of the determination button 120, the first indicator 130A is lit yellow, which is the color that indicates the start of printing. Upon completion of printing, the first indicator 130A is lit blue, which is the color that indicates the completion of printing. Then after passage of a fixed period, lighting of the first indicator 130A is turned OFF. In the case of printing by movement in the second sub-scanning direction, due to control by the indicator display controller 112, the second indicator 130B is lit in the same color as in the case of printing by movement in the first sub-scanning direction. Further, although lighting in a color indicating the completion of printing is described above when printing is completed, such a configuration is not limiting, and lighting of the indicator 130A may be turned OFF when printing is completed.

The print start controller 113 determines whether the handy printer 100 has been moved after pressing of the determination button 120 by the standard distance. Upon determination that the handy printer 100 has been moved by the standard distance, the print start controller 113 causes the print head 150 to start printing by control by the print head controller 114. In the case of printing by movement in the first sub-scanning direction, upon determination that the handy printer 100 has been moved by the standard distance d1 after pressing of the determination button 120, the print start controller 113 causes the magenta-color print head 150M to start printing. Upon determination that the handy printer 100 has been moved by the standard distance d2, the print start controller 113 causes the cyan-color print head 150C to start printing; and upon determination that the handy printer 100 has been moved by the standard distance d3, the print start controller 113 causes the yellow-color print head 150Y to start printing. In the case of printing by movement in the second sub-scanning direction, upon determination that the handy printer 100 has been moved by the standard distance d4 after pressing of the determination button 120, the print start controller 113 causes the yellow-color print head 150Y to start printing. Upon determination that the handy printer 100 has been moved by the standard distance d5, the print controller 113 causes the cyan-color print head 150C to start printing, and upon determination that the handy printer 100 has been moved by the standard distance d6, the print controller 113 causes the magenta-color print head 150M to start printing.

After determination by print start controller 113 that the handy printer 100 has been moved by the standard distance, the print head controller 114 controls the print head 150 to print the image, on the basis of the movement distance in the sub-scanning direction and detected by the movement distance detector 140. Specifically, each time the print head 150 is moved by a distance equivalent to 1dot pitch in the sub-scanning direction, the print head controller 114 causes the print head 150 to print 1dot line that is a line of single pixels arrayed linearly in the main scanning direction for each yellow-magenta-cyan (YMC) color of the image of the print subject stored in the RAM 180. Further, prior to the start of printing, the print head controller 114 causes the print head 150 to be preheated for a fixed period in order to improve the discharging of ink.

On the basis of operation by the user, the determination button 120 is for receiving as a print start position the position at which the first indicator 130A or the second indicator 130B is disposed on the printing medium R, and giving an instruction for the start of printing.

The movement distance detector 140 detects a movement distance that is a distance in which the print head 150 is moved on the printing medium R in the aforementioned manner, and outputs to the controller 110 data indicating the detected movement distance.

In the aforementioned manner, the print head 150, on the basis of control by the print head controller 114 and in accordance with the print data, selectively discharges ink from the nozzles arranged in the print head 150. The discharged ink attaches to the printing medium R, and pixels (1dot line) arrayed linearly in the main scanning direction of the print head 150 are printed. Further, prior to the start of printing, the print head 150 performs the fixed period preheat of the print head 150 in order to improve the discharging of ink.

The communicator 160 receives from the terminal device 200 data indicating the print subject and the movement direction. The communicator 160 includes a wireless communication module such as a wireless local area network (LAN), Bluetooth (R), and the like.

The ROM 170 includes nonvolatile memory such as flash memory, and stores information such as programs for achieving the various functions of the controller 110 as described above and the standard distances d1 to d6. The RAM 180 includes volatile memory and is used as a working region for execution of programs for the controller 110 to perform various types of processing. Further, the RAM 180 stores information such as the print subject YMC image data, the movement direction, a movement distance, and the like.

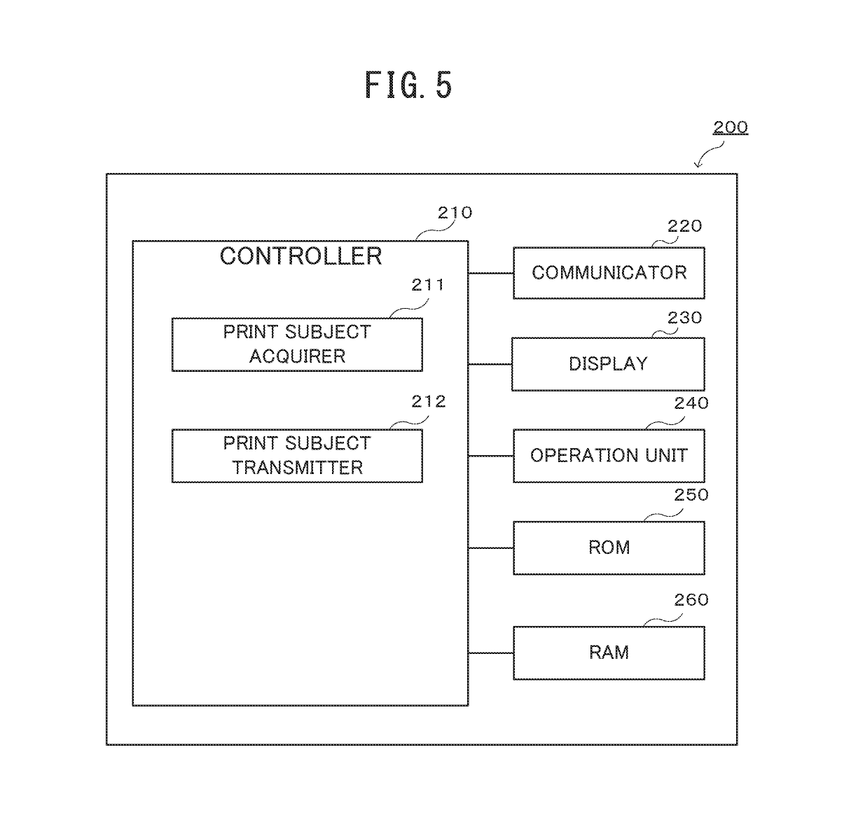

As illustrated in FIG. 5, the terminal device 200 includes a controller 210, a communicator 220, a display 230, an operation unit 240, a ROM 250, and a RAM 260.

The controller 210 includes components such as a CPU. The controller 210 functions as a print subject acquirer 211 and a print subject transmitter 212 by executing a program stored in the ROM 250.

The print subject acquirer 211 acquires data indicating the printing subject that is acquired by an operation unit 240 or is received by the communicator 220. Further, the print subject acquirer 211 acquires data indicating the movement direction acquired by the operation unit 240.

The print subject transmitter 212 transmits data indicating the print subject and the movement direction via the communicator 220 to the handy printer 100. When the movement direction is not acquired by the print subject acquirer 211, the print subject transmitter 212 transmits data indicating the first sub-scanning direction as the movement direction.

The communicator 220 transmits to the handy printer 100 data indicating the print subject and the movement direction. The communicator 220, in a manner similar to the aforementioned communicator 160, includes a wireless communication module such as a wireless LAN, Bluetooth (R), and the like.

The display 230 displays an image of the inputted print subject and/or an image required for operation, and includes components such as a liquid crystal display (LCD).

The operation unit 240, on the basis of an input from the user, receives data that indicates the print subject and movement direction, or receives an instruction indicating the start or stop of print processing. Further, the operation unit 240 and the display 230 are included in a touch panel display device.

The ROM 250 includes nonvolatile memory such as flash memory, and stores programs for the controller 210 to achieve various types of functions. The RAM 260 includes volatile memory and is used as a working region for execution of programs for the controller 210 to perform various types of processing. Further, the RAM 260 stores information indicating the print subject and the movement direction.

Hereinafter, print subject transmission processing concerning print processing executed by the handy printer 100 and print subject transmission processing executed by the terminal device 200 are described in an example of transmission of the print subject to the handy printer 100 from the terminal device 200 having the aforementioned configuration and printing of the print subject by the handy printer 100.

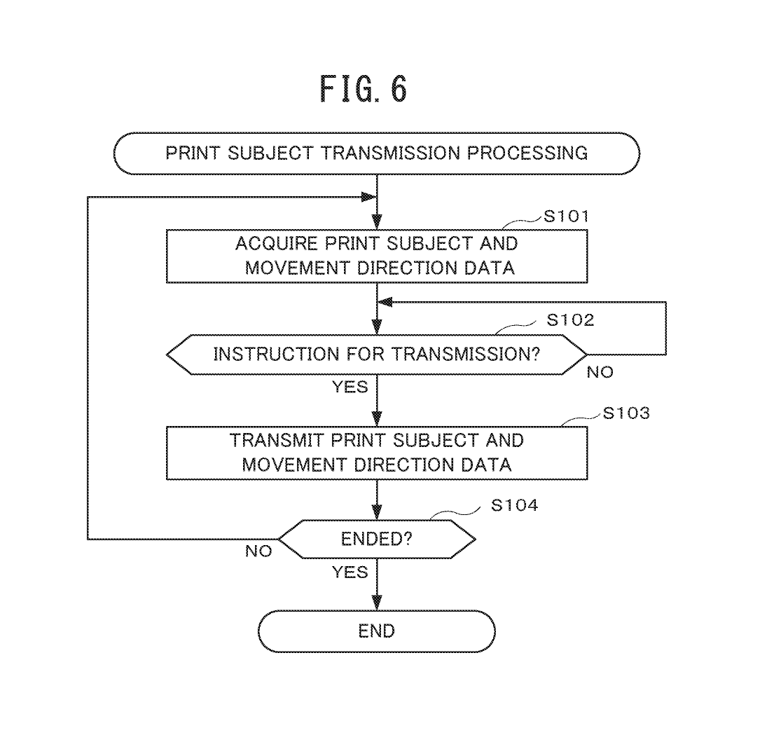

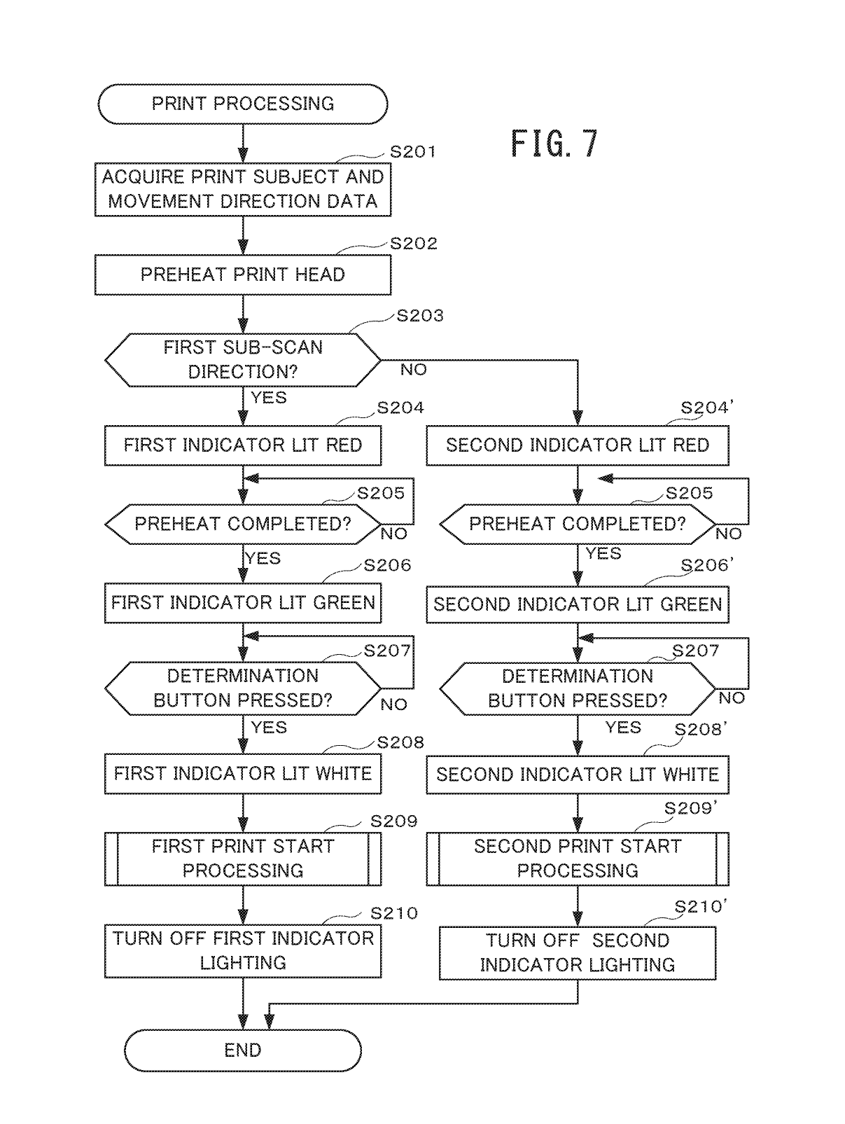

The terminal device 200, in response to an instruction by the user to cause the start of processing, starts the print subject transmission processing illustrated in FIG. 6. Further, the handy printer 100, in response to the instruction by the user to cause the start of processing, starts the print processing illustrated in FIG. 7. The print subject transmission processing executed by the terminal device 200 and the print processing executed by the handy printer 100 are described below with reference to flow charts.

Firstly, as illustrated in FIG. 6, the print subject acquirer 211 acquires data indicating the print subject and the movement direction inputted to the operation unit 240 (step S101). The print subject acquirer 211 stores in the RAM 260 data indicating the acquired print subject. Thereafter, the print subject transmitter 212 determines whether an instruction is received for transmission of data indicating the print subject and the movement direction (step S102). When the instruction for transmission of data is not received (NO in step S102), step S102 is repeated. When the instruction for transmission of data is received (YES in step S102), the print subject transmitter 212 transmits data indicating the print subject and the movement direction to the handy printer 100 via the communicator 220 (step S103). Then a determination is made as to whether an instruction to end the print subject transmission processing is inputted (step S104).

When the instruction to end the print subject transmission processing is not inputted (NO in step S104), the processing is returned to step S101, and steps S101 to S104 are repeated. When the instruction to end the print subject transmission processing is inputted (YES in step S104), the print subject transmission processing ends.

Upon transmission of data from the terminal device 200 indicating the print subject and the movement direction, as illustrated in FIG. 7, the print subject acquirer 111 of the handy printer 100 acquires, and stores in the RAM 180, data indicating the print subject and the movement direction transmitted via the communicator 160 from the terminal device 200 (step S201). Thereafter, the print head controller 114 preheats the print head 150 in order to improve the discharging of ink from the nozzles (step S202).

Thereafter, the indicator display controller 112 determines whether the movement direction acquired from the print subject acquirer 111 is the first sub-scanning direction (step S203). When the determination is made that the movement direction acquired by the print subject acquirer 111 is the first sub-scanning direction (YES in step S203), the first indicator 130A is lit red by control by the indicator display controller 112 (step S204).

Thereafter, the indicator display controller 112 determines whether the preheat (printing preparation) is completed (step S205). The determination of whether preheating is completed is made based on whether a fixed period is passed after the start of the preheat. When the determination is made that the preheat is not completed (NO in step S205), step S205 is repeated. When the determination is made that the preheat is completed (YES in step S205), the first indicator 130A is lit green by control by the indicator display controller 112 (step S206). Due to such processing, the handy printer 100 enters the print wait state.

Thereafter, the indicator display controller 112 determines whether the determination button 120 is pressed (step S207). When the determination is made that the determination button 120 is not pressed (NO in step S207), step S207 is repeated. When the determination is made that the determination button 120 is pressed (YES in step S207), the first indicator 130A is lit white by control by the indicator display controller 112 (step S208). Then the print start controller 113 starts the first print start processing (step S209).

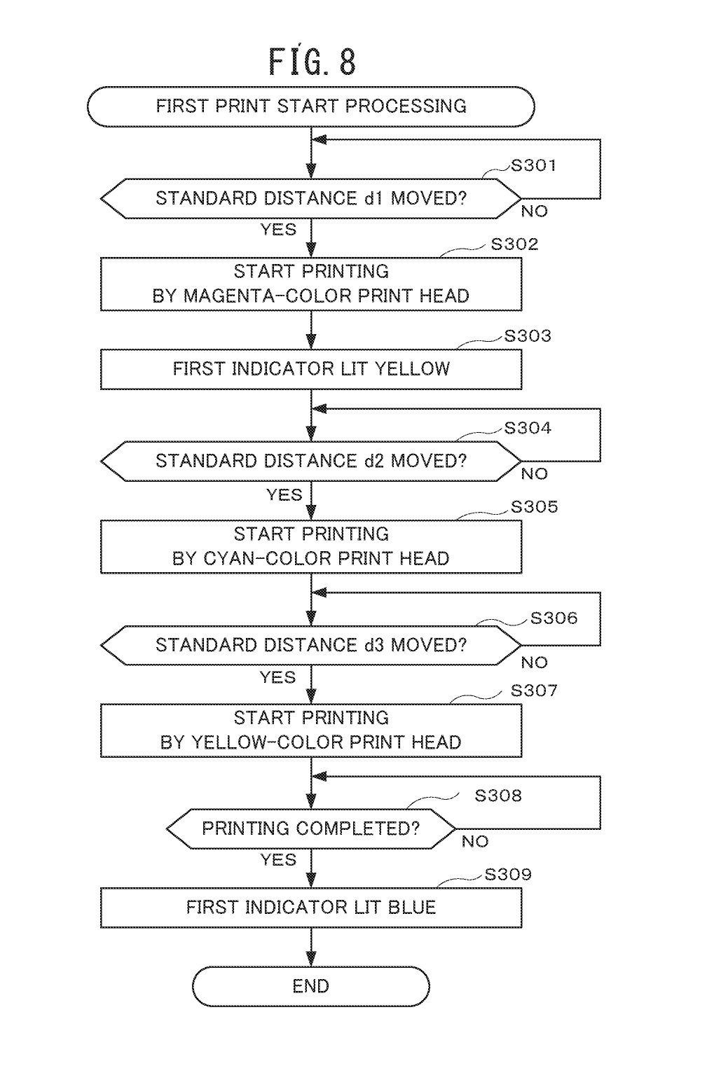

Upon the start of the first print start processing, as illustrated in FIG. 8, the print start controller 113 determines whether the handy printer 100 has been moved by the standard distance d1 after pressing of the determination button 120 (step S301). When the determination is made that the handy printer 100 has not been moved by the standard distance d1 (NO in step S301), step S301 is repeated. When the determination is made that the handy printer 100 has been moved by the standard distance d1 (YES in step S301), the print start controller 113 causes the magenta-color print head 150M to start printing via the print head controller 114 (step S302). Thereafter, the print head controller 114, on the basis of the movement distance in the sub-scanning direction detected by the movement distance detector 140, causes the magenta-color print head 150M to start printing.

Thereafter, the first indicator 130A is lit yellow by control by the indicator display controller 112 (step S303). Then the print start controller 113 determines whether the handy printer 100 has been moved by the standard distance d2 after pressing of the determination button 120 (step S304). When the determination is made that the handy printer 100 has not been moved by the standard distance d2 (NO in step S304), step S304 is repeated. When the determination is made that the handy printer 100 has been moved by the standard distance d2 (YES in step S304), the print start controller 113 causes the cyan-color print head 150C to start printing via the print head controller 114 (step S305).

Thereafter, the print head controller 114, on the basis of the movement distance in the sub-scanning direction detected by the movement distance detector 140, causes the cyan-color print head 150C start printing.

Then the print start controller 113 determines whether the handy printer 100 has been moved by the standard distance d3 after pressing of the determination button 120 (step S306). When the determination is made that the handy printer 100 has not been moved by the standard distance d3 (NO in step S306), step S306 is repeated. When the determination is made that the handy printer 100 has been moved by the standard distance d3 (YES in step S306), the print start controller 113 causes the yellow-color print head 150Y to start printing via the print head controller 114 (step S307). Thereafter, the print head controller 114, on the basis of the movement distance in the sub-scanning direction detected by the movement distance detector 140, causes the yellow-color print head 150Y to start printing.

Thereafter, the indicator display controller 112 determines whether printing is completed (step S308). When the determination is made that printing is not completed (NO in step S308), step S308 is repeated. When the determination is made that printing is completed (YES in step S308), the first indicator 130A is lit blue by control by the indicator display controller 112. Thereafter, the first print start processing ends, and processing is returned to the print processing illustrated in FIG. 7. Thereafter, upon passage of a fixed period, the indicator display controller 112 turns OFF lighting of the first indicator 130A (step S210). The print processing ends thereafter. Although in the present embodiment the indicator display controller 112 turns OFF the lighting of the first indicator 130A upon passage of the fixed period after the print processing, such processing is not limiting, and the lighting may be turned OFF upon determination that printing is completed.

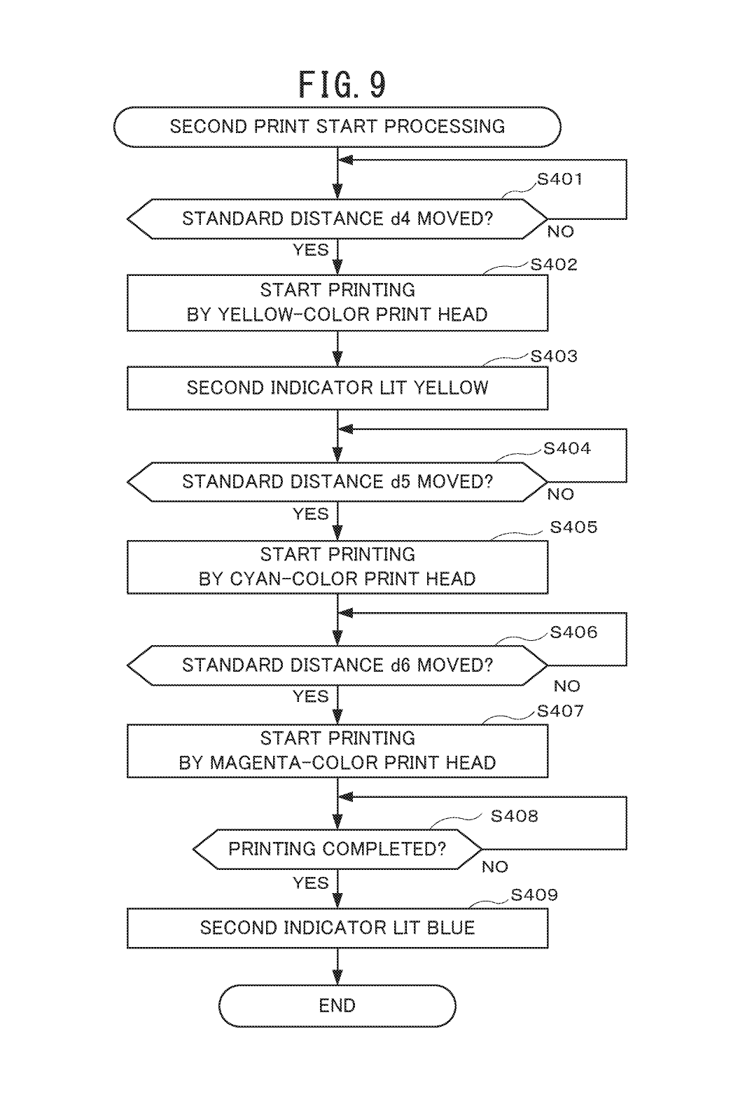

Upon determination that the movement direction acquired by the print subject acquirer 111 is not the first sub-scanning direction, that is to say, is the second sub-scanning direction (NO in step S203), the indicator display controller 112 turns on lighting of the second indicator 130B in a manner similar to the case of printing and scanning in the first sub-scanning direction (steps S204′ to S210′). Further, when the printing is in the second sub-scanning direction, rather than the first print start processing being executed (step S209), the second print start processing is executed (step S209′). In the first print start processing illustrated in FIG. 8, the magenta-color print head 150M is made to start printing (step S302) after scanning by the standard distance d1 (step S301), the cyan-color print head 150C is made to start printing (step S305) after scanning by the standard distance d2 (step S304), and the yellow-color print head 150Y is made to start printing (step S307) after scanning by the standard distance d3 (step S306). Further, the first indicator 130A is lit yellow or blue (step S303 or S309). In contrast, in the second print start processing illustrated in FIG. 9, the yellow-color print head 150Y is made to start printing (step S402) after scanning by the standard distance d4 (step S401) in the second sub-scanning direction, the cyan-color print head 150C is made to start printing (step S405) after scanning by the standard distance d5 (step S404), and the magenta-color print head 150M is made to start printing (step S407) after scanning by the standard distance d6 (step S406). The second indicator 130B is lit yellow or blue (step S403 or S409). The second print start processing is otherwise the same as the first print start processing.

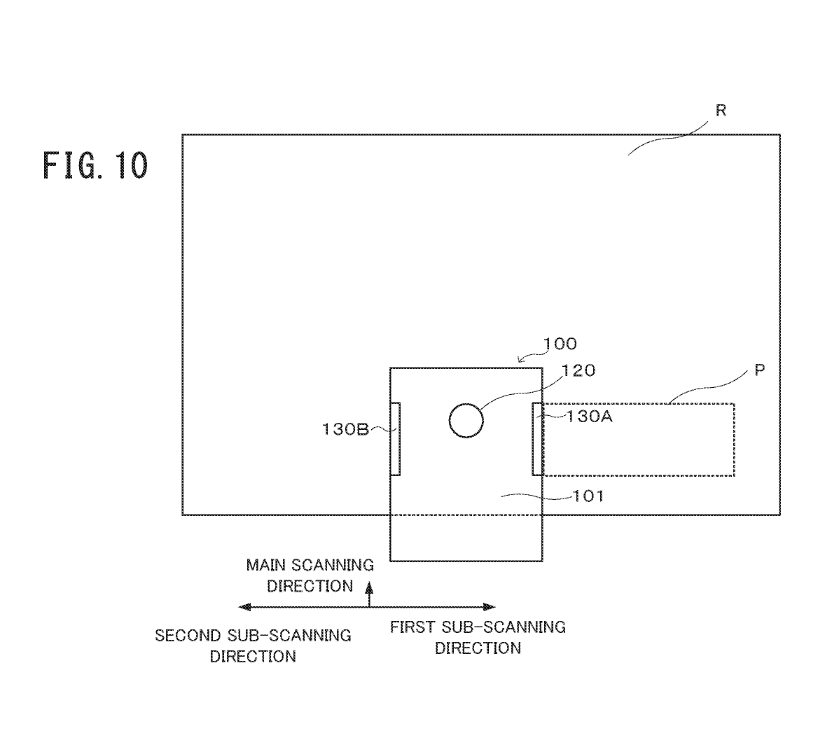

Next, the processing executed by the handy printer 100 and the terminal device 200 according to the present embodiment is described on the basis of a specific example with reference to FIGS. 10 to 12.

When the user positions the first indicator 130A or the second indicator 130B of the handy printer 100 at a position where the user desires printing to start, the user presses the determination button 120, and the user sweeps the handy printer 100 in a certain direction, then printing starts from the position where the first indicator 130A or the second indicator 130B is located at the time of pressing of the determination button 120. Thus the user can print the print subject accurately at the position on the printing medium R. Here, an example is described of printing in the first sub-scanning direction a print subject “ABC” at the planned print position P of the printing medium R illustrated in FIG. 10.

Firstly, in response to an instruction by the user to cause the start of processing, the handy printer 100 starts the print processing, and the terminal device 200 starts the print subject transmission processing. When the terminal device 200 starts the print subject transmission processing, the print subject acquirer 211 acquires data indicating the print subject and the movement direction inputted to the operation unit 240 (step S101, FIG. 6).

Here, the print subject acquired by the print subject acquirer 211 is “ABC”, and the movement direction is the first sub-scanning direction. Thereafter, upon reception of the instruction to transmit data (YES in step S102, FIG. 6), the print subject transmitter 212 transmits via the communicator 220 to the handy printer 100 data indicating the print subject and the movement direction (step S103, FIG. 6). Thereafter, upon input of the instruction to end the print subject transmission processing (YES in step S105, FIG. 6), the print subject transmission processing ends.

Thereafter, upon transmission of data indicating the print subject and the movement direction from the terminal device 200, the print subject acquirer 111 of the handy printer 100 acquires, and stores in the RAM 180, data indicating the print subject and the movement direction transmitted by the terminal device 200 (step S201, FIG. 7). Thereafter, the print head controller 114 preheats the print head 150 in order to improve the discharging of ink from the nozzles (step S202, FIG.7).

Thus the movement direction acquired by the print subject acquirer 111 of the handy printer 100 is the first sub-scanning direction (YES in step S203, FIG. 7), and thus the first indicator 130A is lit red by control by the indicator display controller 112 (step S204, FIG. 7). Then upon determination by the indicator display controller 112 that the preheat is completed (YES in step S205, FIG. 7), the first indicator 130A is lit green (step S206, FIG. 7).

Upon the first indicator 130A being lit green, the user positions the first indicator 130A at the left edge of the planned print position P. When the use presses the determination button 120 (YES in step S207, FIG.7), the first indicator 130A is lit white (step S208, FIG.7). Thereafter, the print start controller 113 starts the first print start processing (step S209, FIG.7).

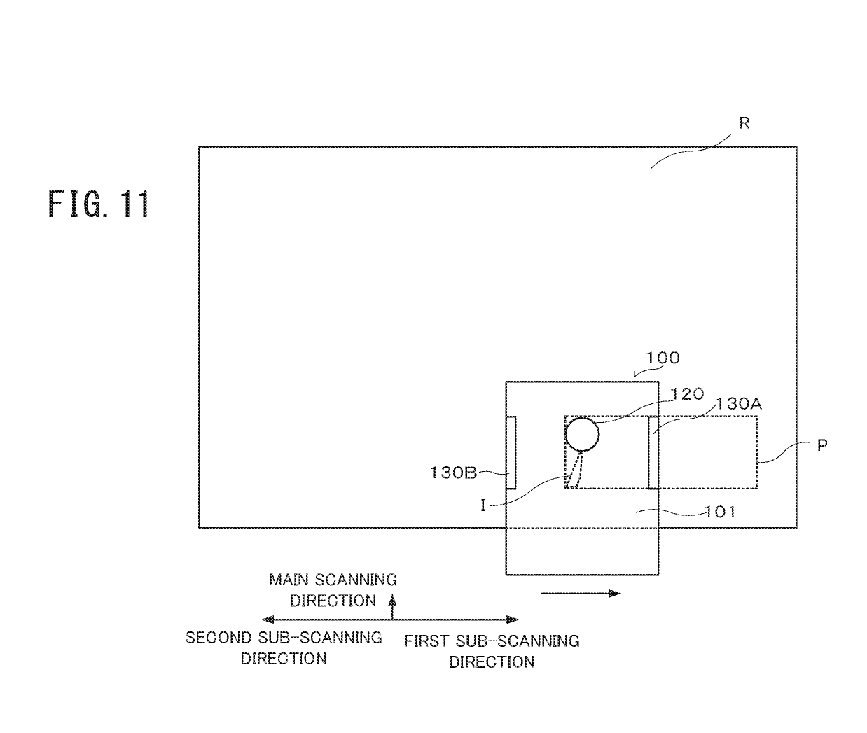

When the handy printer 100 has been moved by the user in the first sub-scanning direction by the standard distance d1 as illustrated in FIG. 11 after the first print start processing starts (YES in step S301, FIG. 8), the print start controller 113 via the print head controller 114 causes the magenta-color print head 150M to start printing (step S302, FIG. 8). Thereafter, the print head controller 114 causes the magenta-color print head 150M to print the image on the basis of the movement distance in the sub-scanning direction detected by the movement distance detector 140. The printing of an image I that is the print subject is started by such processing. Thereafter, the first indicator 130A is lit yellow (step S303, FIG. 8). Although the user is unable to see the printed image I in this state because the printed I is hidden behind the handy printer 100, the yellow lighting of the first indicator 130A enables the user to know that the printing is started.

Thereafter, when the handy printer 100 has been moved by the standard distance d2 (YES in step S304, FIG. 8), the print start controller 113 via the print head controller 114 causes the cyan-color print head 150C to start printing (step S305, FIG. 8). Thereafter, the print head controller 114 causes the cyan-color print head 150C to print the image on the basis of the movement distance in the sub-scanning direction detected by the movement distance detector 140. When the handy printer 100 has been moved by the standard distance d3 (YES in step S306, FIG. 8), the print start controller 113 via the print head controller 114 causes the yellow-color print head 150Y to start printing (step S307, FIG. 8). Thereafter, the print head controller 114 causes the yellow-color print head 150Y to print the image on the basis of the movement distance in the sub-scanning direction detected by the movement distance detector 140.

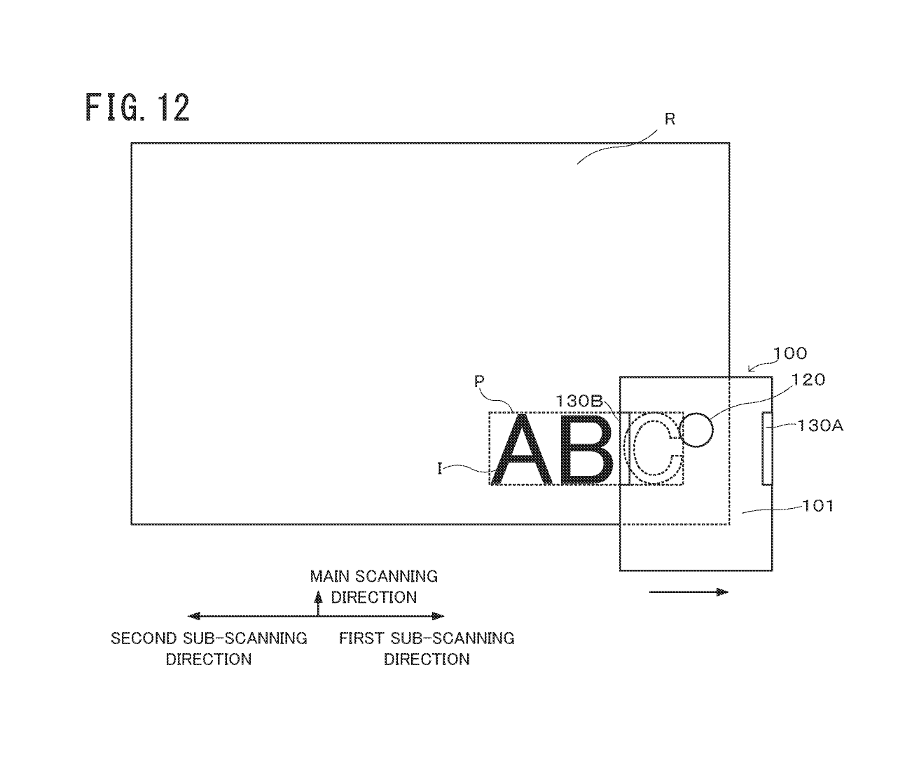

Thereafter, as illustrated in FIG. 12, upon completion of printing (YES in step S308, FIG. 8), the first indicator 130A is lit blue (YES in step S309, FIG. 8). Thereafter, the first print start processing ends, and then processing is returned to the print processing illustrated in FIG. 7. Thereafter, upon passage of a fixed period, the indicator display controller 112 turns OFF lighting of the first indicator 130A (step S210, FIG. 8). Thereafter, the print processing ends.

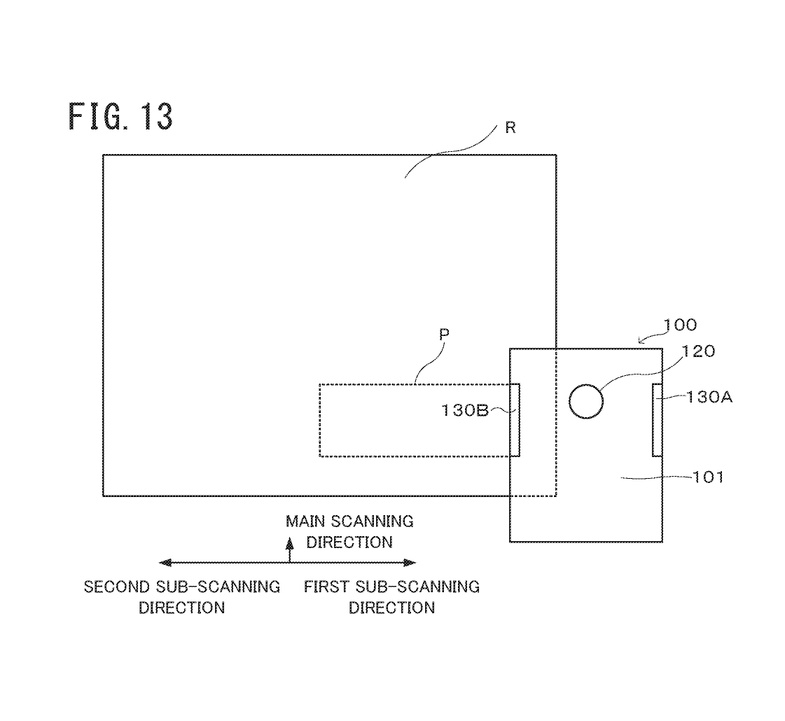

Next, an example is described of accurate printing alignment with the right edge of the planned print position P. In this case, as illustrated in FIG. 13, the second indicator 130B is positioned at the right edge of the planned print position P, and printing is performed by scanning in the second sub-scanning direction.

Firstly, when the terminal device 200starts the print subject transmission processing, the print subject acquirer 211 acquires data indicating the print subject and the movement direction inputted to the operation unit 240 (step S101, FIG. 6). Here, the print subject acquired by the print subject acquirer 211 is “ABC”, and the movement direction is the second sub-scanning direction. Thereafter, upon reception of the instruction to transmit data (YES in step S102, FIG. 6), the print subject transmitter 212 transmits to the handy printer 100 data indicating the print subject and the movement direction (step S103, FIG. 6).

Thereafter, the movement direction acquired by the handy printer 100 is the second sub-scanning direction (NO in step S203, FIG. 7), and thus the second indicator 130B is lit red (step S204′, FIG. 7). Then upon determination that the preheat is completed (YES in step S205, FIG. 7), the second indicator 130B is lit green (step S206′, FIG.7).

Upon the second indicator 130B being lit green, the user positions the second indicator 130B at the right edge of the planned print position P. When the user presses the determination button 120 (YES in step S207, FIG. 7), the second indicator 130B is lit white (step S208′, FIG. 7). Thereafter, the print start controller 113 starts the second print start processing (step S209′, FIG. 7).

When the handy printer 100 has been moved by the user in the sub-scanning direction by the standard distance d4 after the second print start processing starts (YES in step S401, FIG. 9), the print start controller 113 causes the magenta-color print head 150M to start printing (step S402, FIG. 9). The printing of the image I that is the print subject is started by such processing. Thereafter, the second indicator 130B is lit yellow (step S403, FIG. 9). Thereafter, when the handy printer 100 has been moved by the standard distance d5 (YES in step S404, FIG. 9), the cyan-color print head 150C is made to start printing (step S405, FIG. 9). When the handy printer 100 has been moved by the standard distance d6 (YES in step S406, FIG. 9), the yellow-color print head 150Y is made to start printing (step S407, FIG. 9).

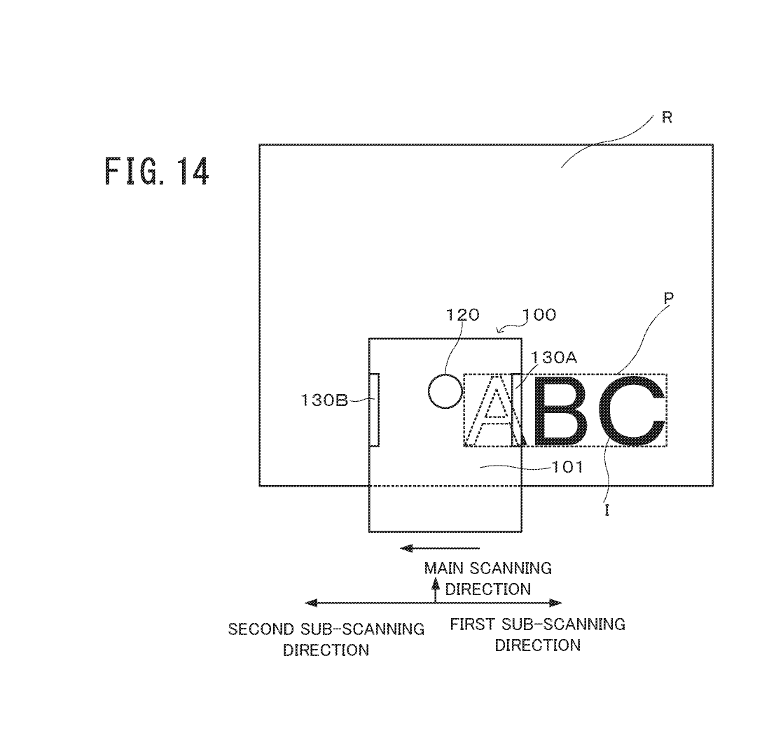

Thereafter, as illustrated in FIG. 14, upon completion of printing (YES in step S408, FIG. 9), the second indicator 130B is lit blue (YES in step S409, FIG. 9). Thereafter, the second print start processing ends, and then processing is returned to the print processing illustrated in FIG. 7. Thereafter, upon passage of a fixed period, the indicator display controller 112 turns OFF lighting of the second indicator 130B (step S210′, FIG. 7). Thereafter, the print processing ends.

According to the handy printer 100 of the present embodiment as described above, the first indicator 130A is positioned at the left edge of the planned print position P, the determination button 120 is pressed, and scanning is performed in the first sub-scanning direction, thereby enabling accurate printing alignment with the left edge of the planned print position P. Alternatively, the second indicator 130B is positioned at the right edge of the planned print position P, the determination button 120 is pressed, and the scanning is performed in the second sub-scanning direction, thereby accurate printing alignment with the right edge of the planned print position P. The user by such operation can print with the left edge or the right edge of the planned print position P accurately positioned. Further, the first indicator 130A and the second indicator 130B each have the same length as the printing width, thereby making the width of printing of the print subject easily understood by the user. Further, by positioning of the lower edge portion or the upper edge portion of the first indicator 130A and the second indicator 130B at the upper edge portion or the lower edge portion of the planned print position P, the upper edge or the lower edge of the print subject can be accurately positioned at the planned print position P. Further, the first indicator 130A and the second indicator 130B are lit red during the preheat and are lit green in the print wait state. Such operation enables the user to know whether the print wait state is entered. Further, the first indicator 130A and the second indicator 130B are lit white when the determination button 120 is pressed, are lit yellow when printing starts, and are lit blue when printing is completed. Thus the user can, even without seeing the printed image I, know that printing is started and completed. Further, the first indicator 130A or the second indicator 130B is lit in accordance with the movement direction, and thus the user can intuitively know the movement direction.

### MODIFIED EXAMPLE

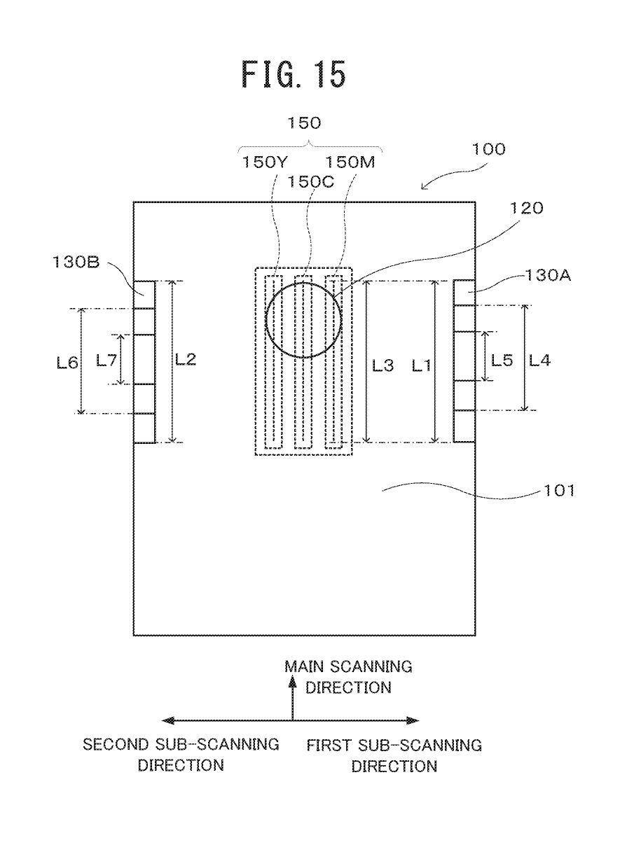

In the handy printer 100 of the aforementioned embodiment, an example is described in which the first indicator 130A and the second indicator 130B are entirely lit. The first indicator 130A and the second indicator 130B may indicate the printing width, and as illustrated in FIG. 15, the length of lighting in the main scanning direction may be switched in three stages. By control by the indicator display controller 112 in accordance with the printing width of the print subject to be printed, the first indicator 130A may be lit along a length L1, for a length L4 shorter than the length L1, or for a length L5 shorter than the length L4. In a similar manner, by control by the indicator display controller 112 in accordance with the printing width of the print subject to be printed, the second indicator 130B may be lit for a length L2, for a length L6 shorter than the length L2, or for a length L7 shorter than the length L6. Specifically, in the case of printing by a font having an approximately medium font size, lighting is turned ON over the length L4 or the length L6. In the case of printing by a small font, lighting is turned ON over the length L5 or the length L7. Such operation enables the user to know the printing width of the print subject. The length of lighting in the main scanning direction of the first indicator 130A and the second indicator 130B may be switched in two stages, or may be switched in four or more stages.

In the aforementioned embodiments, an example is described in which the first indicator 130A and the second indicator 130B have light guide plates and red, green, and blue LEDs. As long as the first indicator 130A and the second indicator 130B can indicate the printing width, the first indicator 130A and the second indicator 130B may include a backlight-attached liquid crystal panel or an organic EL display. Due to configuration of the first indicator 130A and the second indicator 130B in this manner, the width of the print subject can be easily displayed even when the width of the print subject to be printed is narrower than the maximum width.

Although an example is described in the aforementioned embodiments in which the print head 150 discharges from nozzles of magenta-colored, cyan-colored, and yellow-colored inks, the print head 150 may discharge a monochrome ink or inks of two colors, or may discharge inks of four or more colors. Further, although an example is described in which the print head 150 is an inkjet-type and has nozzles that are linearly arrayed, the print head 150 may be a thermal type or another type.

An example is described in the aforementioned embodiments in which red is the color used to indicate that preheating is in progress, green is the color used to indicate the print wait state, white is the color used to indicate the start of scanning, yellow is the color used to indicate the start of printing, and blue is the color used to indicate the completion of printing. However, the color used to indicate that preheating is in progress, the color used to indicate the print wait state, the color used to indicate the start of scanning, the color used to indicate the start of printing, and the color used to indicate completion of printing may each be a different color as long as distinction can be made as to whether preheating is in progress and the like, and brightness may also change. The state of operation may also be recognized via blinking.

Although an example is described in the aforementioned embodiments in which the first indicator 130A and the second indicator 130B are provided, a single indicator may be provided, and the single indicator may be arranged at the right edge or the left edge of the housing 101.

Further, the main parts for performing the processing of the print subject transmission processing and the print processing executed by the handy printer 100 and the terminal device 200 including the CPU, the RAM, the ROM, and the like can be achieved by an ordinary portable information terminal (smartphone, tablet PC), a personal computer, and the like without the use of a dedicated system. For example, a computer program for executing the aforementioned operations can be stored and distributed on a computer-readable recording medium, such as a flexible disc, a compact disc read only memory (CD-ROM), a digital versatile disc read only memory (DVD-ROM), and the like, and then by installing the computer program on the portable information terminal and the like, the portable information terminal and the like may be configured as the information terminal for execution of the aforementioned processing. Further, the computer program may be stored by a storage device included in a server device on a communication network such as the Internet, and the information processing device may be configured by a normal information processing terminal and the like downloading the computer program.

Further, in cases such as those in which the functions of the handy printer 100 and the terminal device 200 are shared by an operating system (OS) and application programs, or in cases in which execution is performed in cooperation between the OS and the application programs, storing of just the application program portion on the recording medium or the storage device is permissible.

Further, the computer program may be superimposed on a carrier wave, and then may be distributed via a communication network. For example, this computer program may be posted to a bulletin board system (BBS) on a communication network, and the computer program may be distributed via the network. Further, a configuration may be used such that the aforementioned processing can be executed by starting and executing the program under control of an operating system (OS) in the same manner as other application programs.

The foregoing describes some example embodiments for explanatory purposes. Although the foregoing discussion has presented specific embodiments, persons skilled in the art will recognize that changes may be made in form and detail without departing from the broader spirit and scope of the invention. Accordingly, the specification and drawings are to be regarded in an illustrative rather than a restrictive detect. This detailed description, therefore, is not to be taken in a limiting sense, and the scope of the invention is defined only by the included claims, along with the full range of equivalents to which such claims are entitled.

What is claimed is:

1. A printing device comprising:
a housing having at a bottom surface thereof a print head in which printing elements are arrayed linearly in a main scanning direction;
a detector configured to detect a movement distance of the housing in a sub-scanning direction;
an inputter configured to input an instruction to start printing;
an indicator disposed on an edge portion of the housing and configured to indicate a planned print position on a printing medium; and
a processor configured to determine whether the housing has been moved in the sub-scanning direction by a standard distance between the indicator and the print head in the sub-scanning direction after inputting by the inputter of the instruction to start printing, and cause the print head to start printing at a start printing position that is a position to which the housing has been moved in the sub-scanning direction by the standard distance.

2. The printing device according to claim 1, wherein a length of the indicator is the same as a length of the print head in the main scanning direction.

3. The printing device according to claim 1, wherein the processor is further configured to
control lighting of the indicator, and
upon completion of printing preparation, cause the indicator to be lit in a color indicating that the printing preparation is completed.

4. The printing device according to claim 1, wherein the processor is further configured to
control lighting of the indicator, and
upon the start of printing, turn on the lighting of the indicator in a color indicating the start of printing.

5. The printing device according to claim 3, wherein the processor is further configured to
upon completion of printing, (i) turn on the lighting of the indicator in a color indicating completion of printing, or (ii) turn off the lighting of the indicator.

6. The printing device according to claim 1, wherein the processor is further configured to
control lighting of the indicator, and
turn on the lighting of the indicator along a length thereof corresponding to a maximum width of an image to be printed by the print head.

7. The printing device according to claim 1, wherein
the indicator comprises a first indicator and a second indicator,
the first indicator is disposed at a position overlapping the print head as viewed from above the housing when the movement distance of the housing is the same as a distance between the first indicator and the print head in a first sub-scanning direction, and
the second indicator is disposed at a position overlapping the print head as viewed from above the housing when the movement distance of the housing is the same as a distance between the second indicator and the print head in a second sub-scanning direction.

8. The printing device according to claim 7, wherein the processor is further configured to
control lighting of the indicator,
turn on lighting of the first indicator when printing is performed by scanning in the first sub-scanning direction, and
turn on lighting of the second indicator when printing is performed by scanning in the second sub-scanning direction.

9. A printing device comprising:
a housing having at a bottom surface thereof a print head in which printing elements are arrayed linearly in a main scanning direction; and
an indicator disposed on an edge portion of the housing and configured to indicate a planned print position on a printing medium, wherein
the indicator has a length that is the same as a length of the print head in the main scanning direction.

10. A printing device comprising:
a housing having at a bottom surface thereof a print head in which printing elements are arrayed linearly in a main scanning direction;
an indicator disposed on an edge portion of the housing and configured to indicate a planned print position on a printing medium; and
a processor configured to control lighting of the indicator, wherein
the processor is configured to, upon the processor causing the print head to start printing, turn on the lighting of the indicator in a color indicating that the printing is started.

11. A printing device comprising:
a housing having at a bottom surface thereof a print head in which printing elements are arrayed linearly in a main scanning direction;
a first indicator;
a second indicator; and
a processor configured to
turn on lighting of the first indicator when printing occurs by scanning in a first sub-scanning direction,
turn on lighting of the second indicator when printing occurs by scanning in a second sub-scanning direction,
wherein the first indicator is disposed at a position overlapping the print head as viewed from above the housing when a movement distance of the housing is the same as a distance between the first indicator and the print head in the first sub-scanning direction, and
wherein the second indicator is disposed at a position overlapping the print head as viewed from above the housing when a movement distance of the housing is the same as a distance between the second indicator and the print head in the second sub-scanning direction.

12. A printing method of a printing device including a housing having at a bottom surface thereof a print head in which printing elements are arrayed linearly in a main scanning direction, a detector for detecting a movement distance of the housing in a sub-scanning direction, and an indicator disposed on an edge portion of the housing for indicating a planned print position on a printing medium, the method comprising:
giving an instruction to start printing;
determining by the detector whether the housing has been moved in the sub-scanning direction after the giving of the instruction to start printing by a standard distance between the indicator and the print head in the sub-scanning direction; and
causing the print head to start printing at a start printing position that is a position to which the housing has been moved in the sub-scanning direction by the standard distance.

13. A non-transitory computer-readable recording medium, storing a program for execution by a computer to control a printing device including a housing having at a bottom surface thereof a print head in which printing elements are arrayed linearly in a main scanning direction, a detector for detecting a movement distance of the housing in a sub-scanning direction, and an indicator disposed on an edge portion of the housing for indicating a planned print position on a printing medium, and an inputter for inputting that the indicator is positioned at an edge portion of the planned print position, the program causing the computer to:
determine by the detector whether the housing has been moved in the sub-scanning direction by a standard distance between the indicator and the print head in the sub-scanning direction after inputting by the inputter, and cause the print head to start printing at a start printing position that is a position to which the housing has been moved in the sub-scanning direction by the standard distance.
